(19) United States
(12) Patent Application Publication
(10) Pub. No.: US 2012/0111313 A1
(43) Pub. Date: May 10, 2012

(54) CHARCOAL IGNITER CHIMNEY WITH FAN

(76) Inventor: Donald H. Stover, Greenville, IL (US)

(21) Appl. No.: 12/941,758

(22) Filed: Nov. 8, 2010

(51) Int. Cl. A47J 37/07

(52) U.S. Cl. 126/25 B

(57) ABSTRACT

A charcoal igniter that quickly and easily lights charcoal bricks without lighter fluid has a generally cylindrical or tubular shape. The tube is hollow and completely open on both ends and has thin walls. The lower end of the tube has an air shaft hole and a smaller igniter hole. An air shaft and fan are attached to the wall of the tube at the air hole. The air shaft slopes downwardly and away from the cylinder has an electric fan at its outer end. Grates cover the air shaft hole in the tube and the outer part of the air shaft near the fan. Charcoal is placed in the bottom part of the tube and paper is loaded on top. More charcoal is loaded on top of that to fill the tube. The paper is then ignited through the igniter hole and the fan is turned on. The fan circulates air vigorously through the tube and the charcoal is lighted evenly and ready to use in about five minutes. The tube may then be removed from the lighted charcoal by simply raising it vertically.

### BACKGROUND OF THE INVENTION

This invention relates to the field of outdoor barbeque grills and fire starters. More particularly, a new and improved chimney for starting charcoal bricks assisted by an external source of air, a fan, is presented.

Outdoor barbeques are common throughout the world. They are generally divided into two types, gas fired and natural or charcoal (briquette or lump) fired. This invention relates to the charcoal brick fired grills.

Charcoal brick fired grills generally have lower charcoal brick containers of some sort, an intermediate grill and an upper lid or other enclosure, although the upper enclosure is optional. In order to start such a grill, charcoal bricks are placed in the lower container and a highly flammable lighter fluid is sprayed on the charcoal. The charcoal bricks and lighter fluid are then ignited and the charcoal bricks are left for 20 minutes to half an hour or longer to ignite and begin to burn sufficiently to burn off the hydrocarbon igniter fluid and cook the meat placed on the intermediate grill. This procedure has several drawbacks, including the need to store a highly flammable and dangerous fluid, the aftertaste of the lighter fluid on the meat to be cooked and the length of time needed to bring the coals to a sufficient temperature. During the usual process, dangerous and harmful volatile organic compounds are also released into the atmosphere.

Several inventions have been patented that solve many of the problems associated with charcoal brick ignition. One of the earliest is the 1985 US patent issued to Gerson for a charcoal lighter device. The Gerson patent (U.S. Pat. No. 4,531,507) discloses a frustro-conical outer shell having an intermediate pivoting grate 16 for supporting the charcoal bricks. Paper is placed in the lower part of the shell and charcoal bricks are placed on top of the grate. Lower air openings 40 draw combustion gases upwards over the charcoal and bricks and they are ignited. (See Gerson, Column 3, lines 22-47.) Gerson uses the outer shell alone as a flue to draw gases upward for complete combustion of the charcoal bricks. When the charcoal bricks are sufficiently ignited, the grate 16 is released and the bricks (C) may be deposited on the support surface (S). The device may then be removed.

Although an advancement on the prior art, the Gerson device still requires approximately the same amount of time to ignite the bricks, that is, 15 minutes to half an hour. It is an object of this invention to provide a charcoal brick device that forces air into the charcoal bricks such that they will ignite and burn to a sufficient heat in less than five minutes.

Another improvement over the simple lighter fluid method was disclosed in the 1995 US patent issued to Stephen (U.S. Pat. No. 5,469,835). Stephen also disclosed a charcoal igniter that does not require the use of lighter fluid. Stephen utilizes a conical grate 32 to help improve the drafting of the hot gases from the ignition paper upward. (See Stephen, Column 3, lines 24-28.)

In both Gerson and Stephen, the necessarily hot outer shell must be removed from the charcoal bricks by performing somewhat complicated maneuvers. In Gerson, the grate must be released and then raised out of the path needed to release the bricks onto surface S. In Stephen the entire device must be picked up and turned to a slightly downward angle or turned upside-down. While the maneuvers required in each of these inventions would be simple under ordinary circumstances, the presence of very hot charcoal bricks makes the maneuvers tricky and even dangerous. It is another object of this invention to provide a charcoal starter that does not require either lighter fluid or any complicated maneuvers to empty the burning charcoal bricks onto the grill container.

Further and other objects of this invention will become apparent upon reading the below description of the invention.

### BRIEF DESCRIPTION OF THE INVENTION

The charcoal igniter chimney has a generally tubular shape in the preferred embodiment with thin walls and a generally circular cross-section. The tube is open at both the top and bottom. The lower part of the tube has an air shaft opening and a small igniter hole cut out of it. Connected to the air shaft opening is a generally cylindrical air shaft with an electric fan or blower at the far end. A grate separates the air shaft cylinder from the tubular casement. The air shaft slopes away and downwardly from the casement. To use the device, charcoal bricks are loaded into the lower part of the casement to about the level of the igniter hole. Paper is then placed on top of this lower charcoal and upper charcoal is loaded into the casement on top of the paper. The paper is ignited using the igniter hole. The fan is switched on and a draft is created, lighting the charcoal bricks and brining them to the desired cooking temperature and consistency within a few minutes. Inclusion of paper laced with vegetable oil as an added initial accelerant is a possible enhancement to the process on cold winter days.

### BRIEF DESCRIPTION OF THE DRAWING FIGURES

FIG. 1 is a perspective view of the invention.

FIG. 2 is a side view of the device.

FIG. 3 is a side cutaway view of the device with the lower charcoal bricks in the chimney.

FIG. 4 is a side cutaway view of the device with the lower charcoal bricks and the combustible material in place.

FIG. 5 is a side cutaway view of the device showing the loading of the upper charcoal bricks.

FIG. 6 is a side cutaway view of the device fully loaded and ready for ignition.

FIG. 7 is a side partial cutaway view of the device showing the chimney fully loaded and the igniter in the lighter hole ready for ignition.

### DETAILED DESCRIPTION OF THE INVENTION

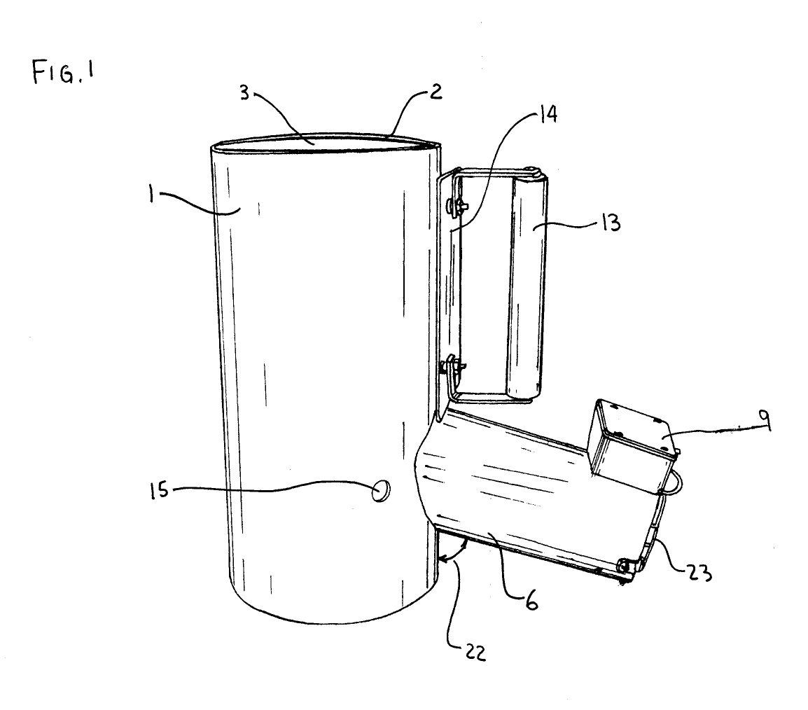

A charcoal igniter chimney has a hollow outer casement 1 with thin generally vertical walls 2. The outer casement 2 may be made of 22 gauge steel, commonly known as black stove pipe. The 22 gauge steel is preferred because it will retain its shape under the extreme heat of burning charcoal bricks but is still lightweight and readily maneuverable. However, the type and gauge thickness of metal used is a matter of construction and is not meant as a limitation on the invention. Other types of materials may be used in practicing this device. The casement 1 has a completely open top 3 (as best shown in FIG. 1) and bottom 4.

The lower part of the casement wall 2 has a lower air opening hole 5. A hollow air shaft 6 has one end connected to the casement wall 2 at the air shaft opening hole 5 end to create an air passageway between the fan or blower 7 and the wall 2 of the casement. A blower fan 7, fan motor 8 and fan housing 9 are attached to air shaft 6 at the fan end of the air shaft 6. The fan end of the air shaft is open to outside air but is covered by fan end grate 23.

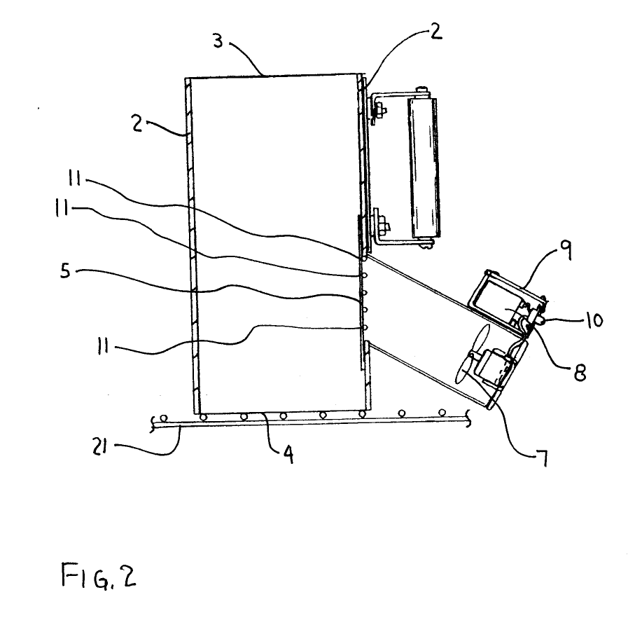

The fan or blower 7 is energized by an electric motor 8 located on the outside of air shaft as best shown in FIGS. 1-3. The fan is operated by switch 10 located on the housing 9. The switch may be a simple on-off switch or may be a variable switch to vary the fan speed. In order to keep the charcoal bricks inside the casement 1, an air shaft grate 11 is placed over the air shaft opening hole 5 as best shown in FIG. 2.

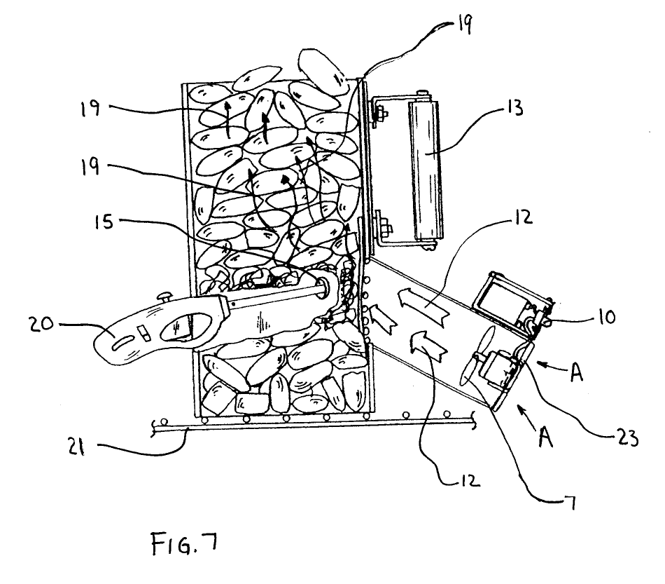

The fan 7 is open on the far end and forces oxygen rich outside air A through the fan end grate 23 towards the wall grate 12. When the fan is turned “on”, the air shaft air flow 12 is as best shown in FIG. 7. The fan circulates the outside air A from through the fan end grate 23 to the casement air opening hole end of the air shaft and through the inside of the casement 1. An air shaft grate 11 is located at the air shaft opening hole 5 and covers the hole.

Also attached to the upper part of wall 2 of casement 1 is a handle 13. Since the casement 1 is designed to contain ignited and extremely hot charcoal bricks and has thin walls, a handle insulator 14 is attached between the handle 13 and the casement wall 2. This insulator makes it possible for a user to grasp the handle after the charcoal bricks are hot without burning himself.

Also located in the lower part of the casement wall 2 is an igniter hole 15.

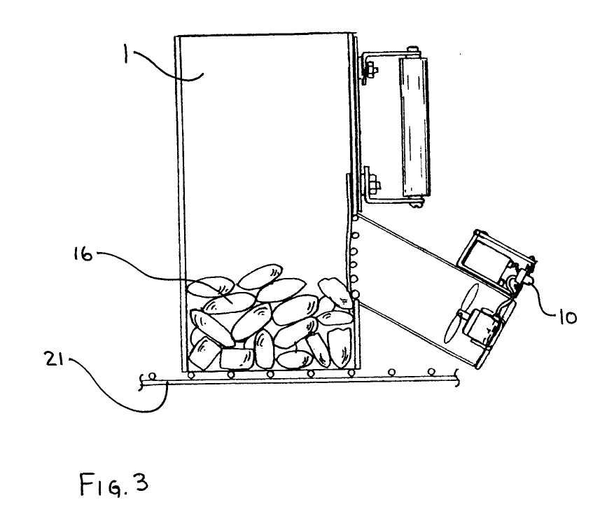

The use of the charcoal igniter chimney is shown in FIGS. 3-7. The casement chimney 1 is placed on top of a charcoal grill 21 as shown in FIG. 3. Lower charcoal bricks 16 are then loaded inside the casement chimney 1. The lower charcoal bricks 16 are loaded to approximately the lower edge of the air shaft 6. This level is generally about the lower one-third of casement chimney 1.

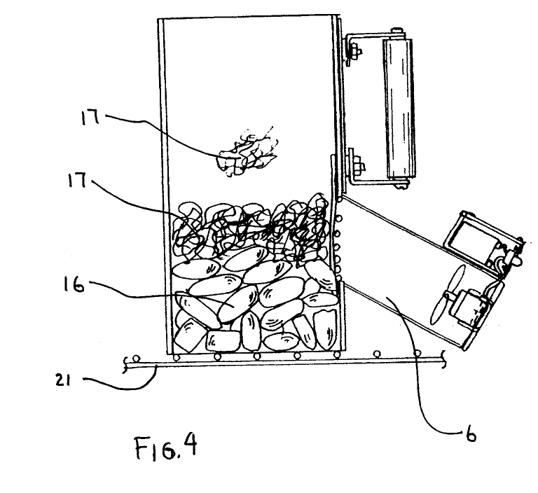

As shown in FIG. 4, paper or other combustible material 17 is then loaded on the inside of casement chimney 1.

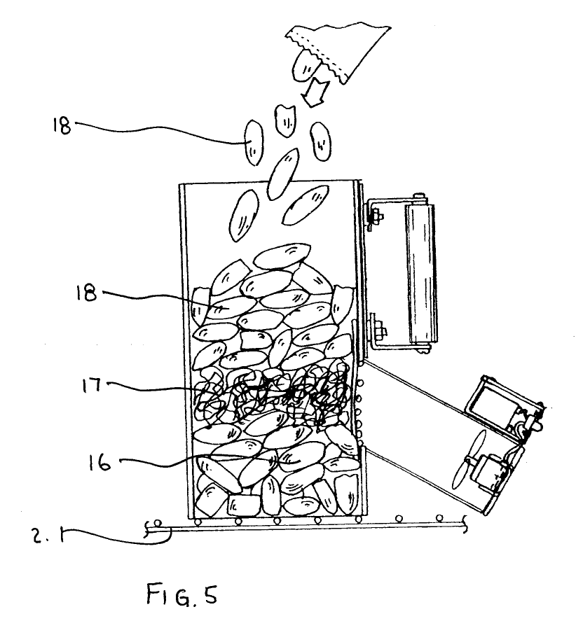

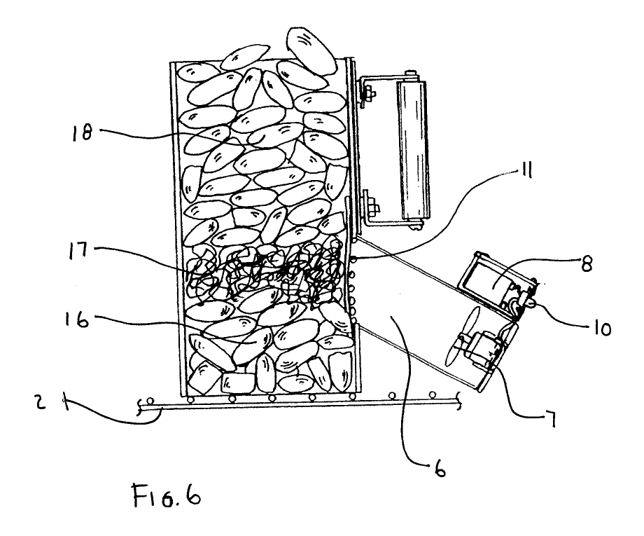

Upper charcoal bricks 18 are then loaded on the paper 17 and lower bricks 16 as shown in FIG. 5. The fully loaded casement chimney 1 is shown in FIG. 6.

As best shown in FIG. 7, the device is now ready to ignite the charcoal in a fast and efficient manner without the use of lighter fluid. A standard lighter 20 is inserted into the lighter hole 15 and the paper material 17 is ignited. Any type of flame up to and including a handheld propane torch can be used.

The fan switch 10 is activated and outside air A is drawn through fan end grate 23, past fan 7, through air shaft 6 and air shaft grate 11 and into the fully loaded casement 1. The combination of the lighted paper material 17 and the casement air flow 19 quickly ignites all of the charcoal bricks (16 and 18) evenly. The forced air (A and 12 and 19) lights the charcoal and leaves no “hot-spots.” Using the instant device, the charcoal bricks are evenly and uniformly ignited. The entire charcoal brick array is easily, uniformly and quickly ignited and brought to functional temperatures for charcoal grilling. The charcoal bricks light and are brought to temperature in about 5 minutes on average, some 3 to 6 times faster than using conventional methods. In addition, the charcoal bricks burn evenly and uniformly.

Once the charcoal bricks are suitably ignited the whole casement 1 may be removed by simply raising it vertically by the handle and allowing the burning charcoal bricks to drop onto the grill.

The air shaft 6 slopes away from the casement wall 2 and downwardly at an angle 22 of approximately 30 degrees as best shown on FIG. 1. This downwardly sloping angle provides some updraft even without the aid of the electric fan 7 should there be an unexpected failure of the air supply system (fan).

The preferred embodiment of the invention is shown in the drawing figures. The preferred shape of the casement 1 and the air shaft 6 is cylindrical or tubular as shown. However, the casement could be of any suitable geometric shape. For example, the casement and air shaft could have square, rectangular, octagonal or other cross-sections while still keeping within the spirit and disclosure if this invention. While a fan as shown is preferred, any type of forced-air device such as blower could also be used to force outside air A through the air shaft and casement.

Having fully described my device, I claim:

1. A charcoal igniter for charcoal bricks comprising:
(a) a hollow outer casement open at the top and bottom having an air opening hole and an igniter hole located in the lower part of said casement;
(b) a hollow air shaft having one end attached to said casement at an air opening hole end and having an open fan end;
(c) a fan energized by an electric motor attached at the fan end of said air shaft;
(d) an air shaft grate attached to said casement and covering said air shaft hole;
(e) a handle attached to the outside of said casement.

2. A charcoal igniter for charcoal bricks as in claim 1, further comprising a variable speed switch wherein the air flow of said device may be varied.

3. A charcoal igniter for charcoal bricks as in claim 1, wherein the side of said casement is generally vertical and wherein said air shaft angles downwardly and away from the horizontal side of said casement.

4. A charcoal igniter for charcoal bricks as in claim 1, wherein said air shaft angles downwardly and away from the generally horizontal side of said casement at an angle of approximately 30 degrees.

5. A charcoal igniter for charcoal bricks as in claim 1, wherein the cross-section of said casement is circular.

6. A charcoal igniter for charcoal bricks as in claim 1, wherein the cross-section of said air shaft is circular.

7. A charcoal igniter for charcoal bricks as in claim 1, wherein the cross-section of said air shaft is square.
